(19) United States
(12) Patent Application Publication
(10) Pub. No.: US 2012/0017217 A1
(43) Pub. Date: Jan. 19, 2012

(54) MULTI-CORE PROCESSING SYSTEM AND COMPUTER READABLE RECORDING MEDIUM RECORDED THEREON A SCHEDULE MANAGEMENT PROGRAM

(75) Inventors: Keiichi Umezawa, Kahoku (JP); Takehiko Murata, Kahoku (JP)

(73) Assignee: FUJITSU LIMITED, Kawasaki-shi (JP)

(21) Appl. No.: 13/070,933

(22) Filed: Mar. 24, 2011

(30) Foreign Application Priority Data
Jul. 13, 2010 (JP) 2010-158935

(51) Int. Cl. G06F 9/46

(52) U.S. Cl. 718/102

(57) ABSTRACT

A multi-core processor system has a processing order manager which manages command blocks in a lock acquired state under exclusive control, an assigner which assigns a command block managed by the processing order manager to one of the processor cores, an exclusion manager which manages command blocks in a lock acquisition waiting state under the exclusive control, and a transfer controller which, when the command block in the lock acquisition waiting state managed by the exclusion manager gets into the lock acquired state, releases the command block from the exclusion manager, and registers the command block in the processing order manager, thereby efficiently processing tasks.

### CROSS-REFERENCE TO RELATED APPLICATIONS

This application is based upon and claims the benefit of priority of the prior Japanese Patent Application No. 2010-158935, filed on Jul. 13, 2010, the entire contents of which are incorporated herein by reference.

### FIELD

The embodiments discussed herein are directed to a technique of scheduling in a multi-core processing system which has a plurality of processor cores and executes a task having a plurality of threads to be implemented in a specific execution order in each of the processor cores.

### BACKGROUND

FIG. 21 is a diagram schematically illustrating a hardware constitution of an information processing apparatus.

The information processing apparatus 1000 illustrated in FIG. 21 is a storage, for example, which is connected to a host 1001 to successively process commands transmitted from the host 1001.

The information processing apparatus 1000 has, as illustrated in FIG. 21, an Host Bus Adapter (HBA) module 1003, a Central Processing Unit (CPU) core 1004, a memory 1005, a backend module 1006 and a plurality of hard disks 1007.

In the information processing apparatus 1000, a real-time Operation System (OS) operates in the CPU core 1004, and a command having arrived from the host 1001 is written in the memory 1005 via the HBS module 1003. Thereafter, the command is processed by firmware operating on the real-time OS and written in the hard disk 1007 via the backend module 1006.

The information processing apparatus 1000 is in uni-processing system environments having one CPU core 1004.

FIGS. 22 and 23 are diagrams illustrating a task switching manner in a uni-processing system, each of which shows an example where two tasks, task A and task B, are switched.

In processing a plurality of tasks in a uni-processing system environments, there is known a manner in which the tasks are switched according to the priority as illustrated in FIG. 22, for example.

Meanwhile, a processor having a plurality of CPU cores comes to be used in these years. An embedded apparatus such as a storage can employ such a processor having a plurality of CPU cores, whereby it is expected that effective use of these plural CPU cores improves the performance.

In order to improve the performance, plural CPU cores can be used as an SMP (Symmetric Multiple Processor). When a plurality of tasks are scheduled by applying the general SMP manner on a real-time OS, the scheduling is performed by dynamically assigning the tasks to the CPU cores (Patent Document 1 below, for example).
[Patent Document 1] Japanese Patent Application Laid-Open Publication No. 2006-39821

However, such known task scheduling manner yields a delay of the task switching time because switching of the whole context (register space, mapping, stack, etc.) for the task is required when the task is switched.

### SUMMARY

According to an aspect of the invention, a multi-core processor system has a plurality of processor cores and executes a task having a plurality of threads to be implemented in a specific execution order in each of the processor cores. The multi-core processor system comprises a processing order manager that manages a command block in a lock acquired state under exclusive control, an assigner that assigns the command block managed by the processing order manager to one of the processor cores, an exclusion manager that manages a command block in a lock acquisition waiting state under the exclusive control, and a transfer controller that, when the command block in the lock acquisition waiting state managed by the exclusion manager gets into the lock acquired state, releases the command block from the exclusion manager, and registers the command block in the processing order manager.

According to another aspect of the invention, a computer readable recording medium is recorded thereon a schedule management program instructing a computer to execute a scheduling function in a multi-core processor system having a plurality of processor cores and executing a task having a plurality of threads to be implemented in a specific execution order in each of the processor cores. The schedule management program instructs the computer to function as a processing order manager that manages a command block in a lock acquired state under exclusive control, an assigner that assigns the command block managed by the processing order manager to one of the processor cores, an exclusion manager that manages a command block in a lock acquisition waiting state under the exclusive control, and a transfer controller that, when the command block in the lock acquisition waiting state managed by the exclusion manager gets into the lock acquired state, releases the command block from the exclusion manager, and registers the command block in the processing order manager.

According to another aspect of the invention, a method for processing a task having a plurality of threads to be implemented in a specific execution order, in processor cores included in a multi-core processor system comprises managing a command block in a lock acquired state under exclusive control using a first managing queue, assigning the command block managed in the first managing queue to one of the processor cores, managing a command block in a lock acquisition waiting state under the exclusive control using a second managing queue, and when the command block in the lock acquisition waiting state managed in the second managing queue gets into the lock acquired state, releasing the command block from the second managing queue, and registering the command block in the first managing queue.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram schematically illustrating a functional constitution of a scheduler in an information processing apparatus as one example of embodiments;

FIG. 2 is a diagram schematically illustrating a hardware constitution of the information processing apparatus as one example of the embodiments;

FIG. 3 is a diagram schematically illustrating a processing manner of the scheduler in the information processing apparatus as one example of the embodiments;

FIG. 4 is a diagram schematically illustrating a command block in the information processing apparatus as one example of the embodiments;

FIG. 5 is a diagram illustrating a data managing method with MutexQ and MSGQ in the information processing apparatus as one example of the embodiments;

FIG. 6 is a diagram illustrating a state in which a thread set is duplicated and multiplexed in the information processing apparatus as one example of the embodiments;

FIG. 7 is a diagram illustrating an example of exclusion ID management table in the information processing apparatus as one example of the embodiments;

FIG. 8 is a diagram schematically illustrating sending of processing of command blocks in the information processing apparatus as one example of the embodiments;

FIG. 9 is a diagram illustrating an exclusion function among threads in the information processing apparatus as one example of embodiments;

FIG. 10 is a diagram illustrating the exclusion function among threads in the information processing apparatus as one example of the embodiments;

FIG. 11 is a diagram illustrating the exclusion function among threads in the information processing apparatus as one example of the embodiments;

FIG. 12 is a diagram illustrating a command execution order assurance function in the information processing apparatus as one example of the embodiments;

FIG. 13 is a diagram illustrating an exclusion ID management table referring method in the information processing apparatus as one example of the embodiments;

FIG. 14 is a diagram illustrating a modification of the command execution order assurance function in the information processing apparatus as one example of the embodiments;

FIG. 15 is a diagram illustrating a weak CPU affinity function in the information processing apparatus as one example of the embodiments;

FIG. 16 is a diagram illustrating the weak CPU affinity function in the information processing apparatus as one example of the embodiments;

FIG. 17 is a diagram illustrating the weak CPU affinity function in the information processing apparatus as one example of the embodiments;

FIG. 18 is a diagram illustrating the weak CPU affinity function in the information processing apparatus as one example of the embodiments;

FIG. 19 is a diagram illustrating a case where the weak CPU affinity function is not assured in the information processing apparatus as one example of the embodiments;

FIG. 20 is a diagram illustrating a strong CPU affinity function in the information processing apparatus as one example of the embodiments;

FIG. 21 is a diagram schematically illustrating a hardware configuration of an information processing apparatus;

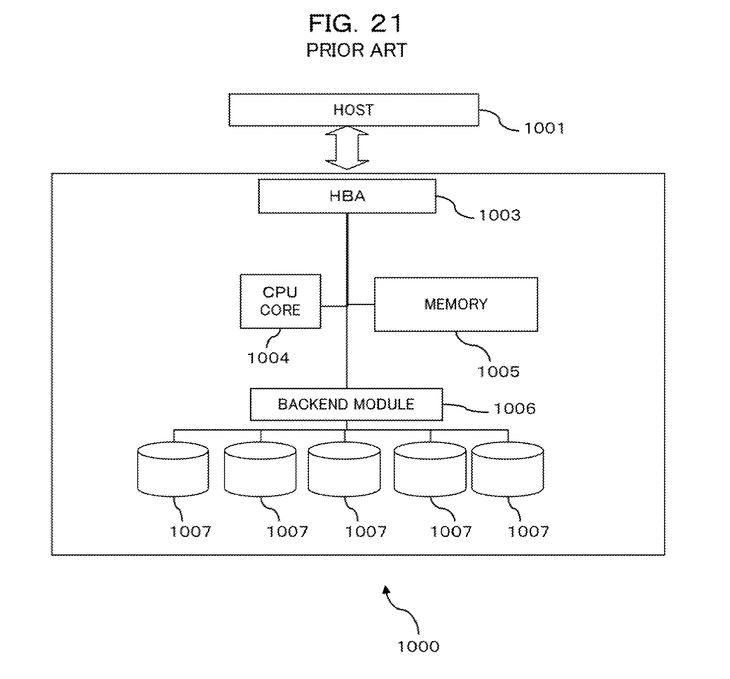

FIG. 22 is a diagram illustrating a task switching method in a uni-processing system; and

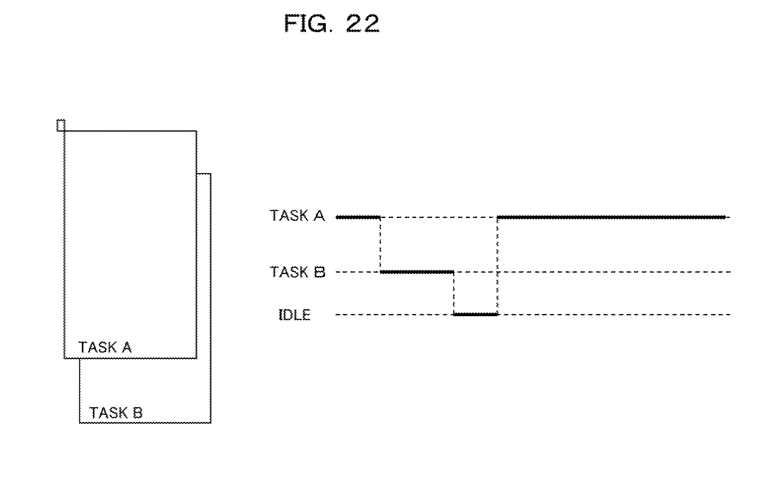

FIG. 23 is a diagram illustrating a task switching method in another uni-processing system.

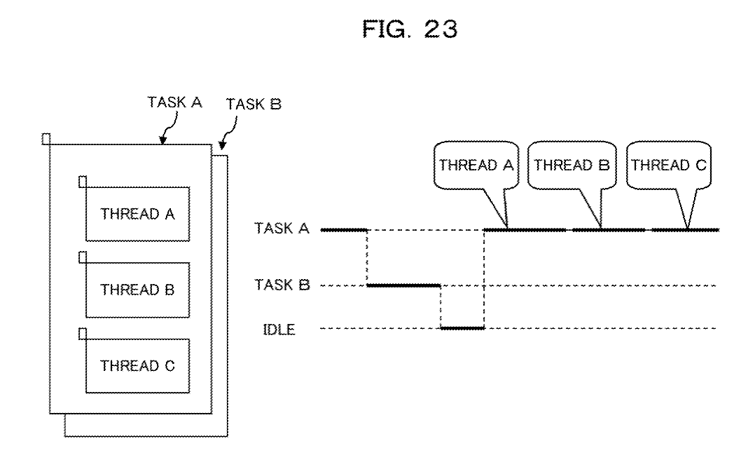

### DESCRIPTION OF EMBODIMENT(S)

Hereinafter, embodiments of a multi-core processor system will be described with reference to the accompanying drawings.

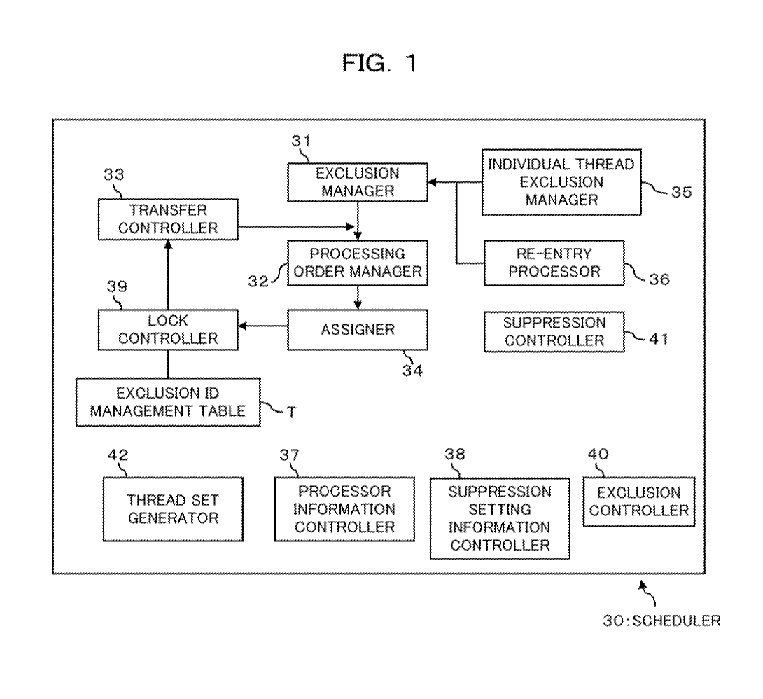

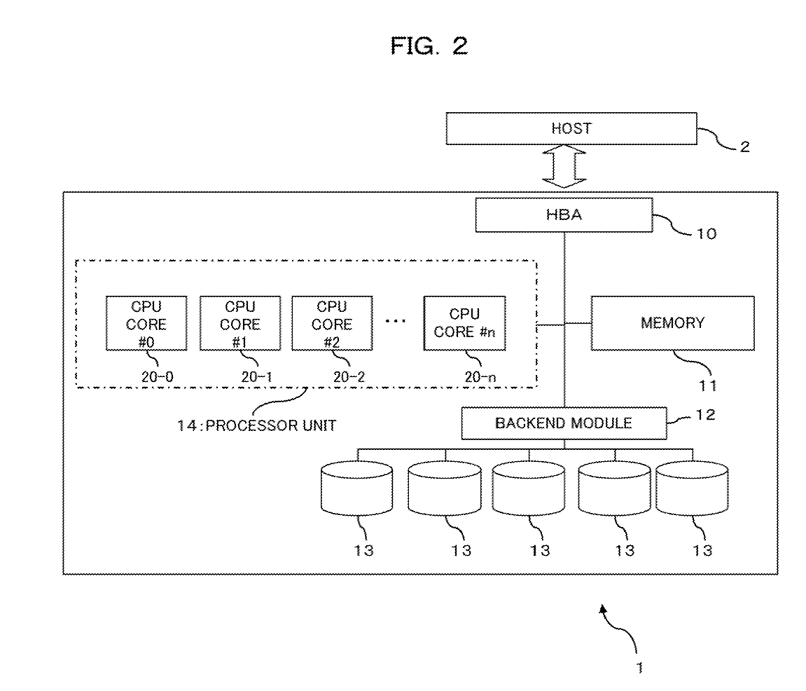

FIG. 1 is a diagram schematically illustrating a functional constitution of a scheduler in an information processing apparatus 1 as one example of the embodiments. FIG. 2 is a diagram schematically illustrating a hardware constitution of the information processing apparatus 1.

The information processing apparatus 1 is a computer communicably connected to a host 2 through a communication line to successively process commands transmitted from the host 2, as illustrated in FIG. 2. The information processing apparatus 1 is a storage, for example.

In the example illustrated in FIG. 2, the information processing apparatus 1 has an HBA module 10, a processor unit 14, a memory 11, a back-end module 12 and a plurality of storages 13.

Each of the storages 13 is a memory such as a hard disk drive (HDD), an Solid State Drive (SSD) or the like, which readably stores various data. The information processing apparatus 1 uses these plural storages 13 to realize Redundant Arrays of Inexpensive Disks (RAID), thereby functioning as a RAID apparatus.

The back-end module 12 performs an access process to the storage 13, which accesses to a predetermined position in a storage area of the storage 13 to write or read data. The HBA 10 is a communication device used to communicably connect the information processing apparatus 1 to the host 2.

The memory 11 is a storage device which temporarily stores (loads) various data and program when the program is executed in the processor unit 14.

The processor unit 14 is a multi-core processor having n (n is a natural number not less than two) CPU cores (processor cores) 20-1 to 20-n. Incidentally, as reference character denoting the CPU core, reference number 20-1, 20-2, . . . or 20-nis used when it is necessary to specify one of the plural CPU cores, while reference number 20 is used when an arbitrary CPU core is specified. A figure following “-” (hyphen) in a sign representing a CPU core is an identifier (CPU identification ID) used to specify the CPU core 20, which is also used as the number of a CPU in charge (CPU-in-charge number) to be described later. Individual CPU core 20 is occasionally represented as “CPU core #1” with a combination of a sing “#” and a CPU identification ID.

In the information processing apparatus 1, these CPU cores 20 are used as an SMP.

The information processing apparatus 1 accepts a storage command transmitted from the host 2, performs a process relating to the storage command, and writes data in or reads data from the storage 13.

In other words, in the information processing apparatus 1, plural processes such as accepting a command, processing, writing (reading), etc. are executed in a predetermined order.

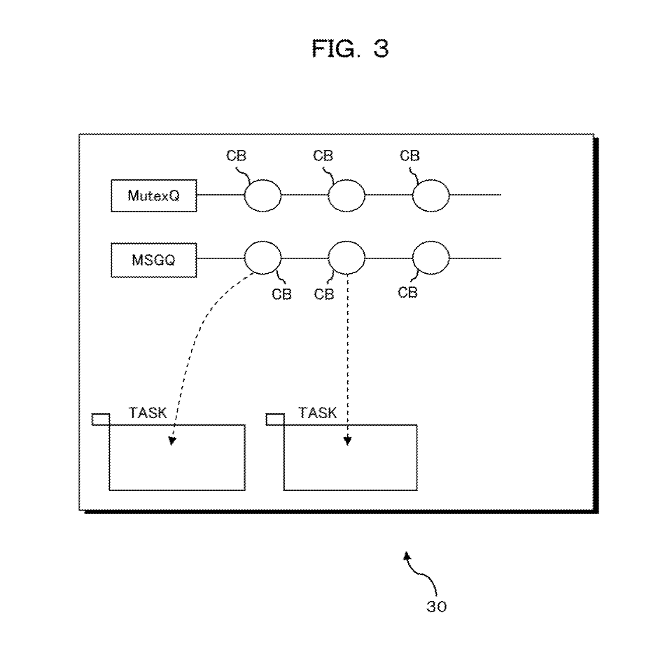

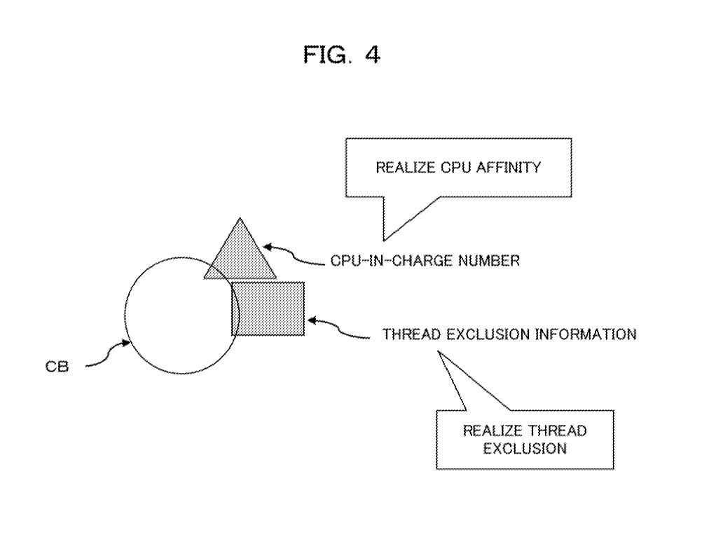

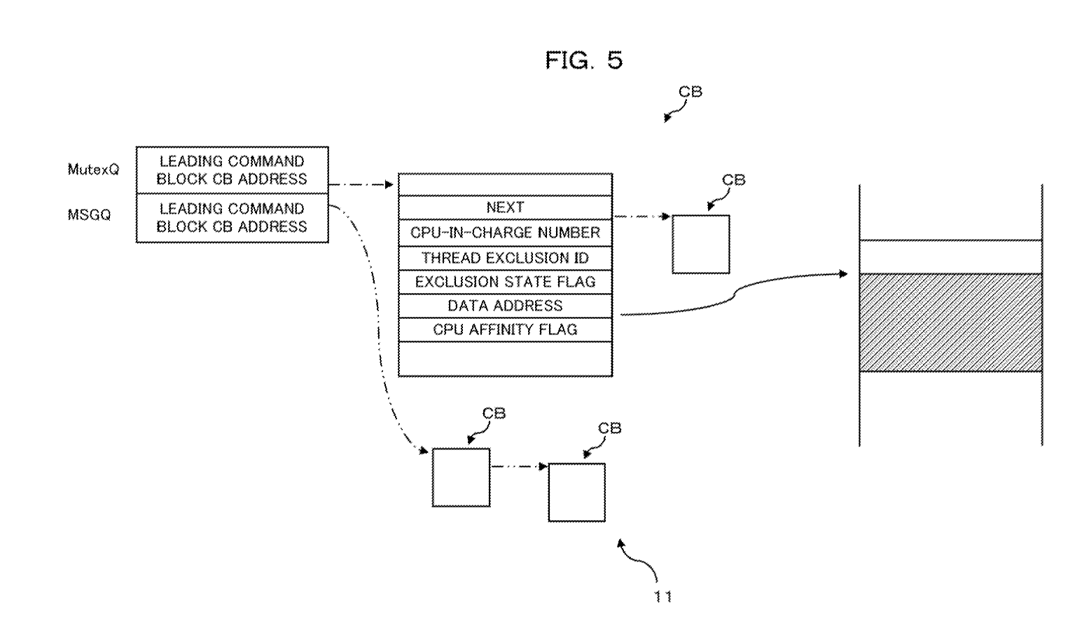

FIG. 3 is a diagram schematically illustrating a processing manner by the scheduler in the information processing apparatus 1 as one example of the embodiments. FIG. 4 is a diagram schematically illustrating a command block CB in the information processing apparatus 1 as one example of the embodiments. FIG. 5 is a diagram illustrating a data management method with the use of MutexQ and MSGQ in the information processing apparatus 1 as one example of the embodiments.

The information processing apparatus 1 is constituted as a multitask system which can simultaneously process a plurality of tasks. The information processing apparatus 1 divides each task into threads sharing a context, and switches these threads. Here, “thread” is a unit of program, and is a group of functions, for example.

The thread scheduler 30 is a function realized by executing a schedule management program by any one of the CPU cores 20 in the processor core 14 or another processor. The thread scheduler 30 has, as illustrated in FIG. 1, functions as an exclusion manager 31, a processing order manager 32, a transfer controller 33, an assigner 34, an individual thread exclusion manager 35, a re-entry processor 36, a processor information controller 37, a suppression setting information controller 38, a lock controller 39, an exclusion controller 40, a suppression controller 41 and a thread set generator 42.

A program (schedule management program) functioning as the exclusion manager 31, the processing order manager 32, the transfer controller 33, the assigner 34, the individual thread exclusion manager 35, the re-entry processor 36, the processor information controller 37, the suppression setting information controller 38, the lock controller 39, the exclusion controller 40, the suppression controller 41 and the thread set generator 42 is provided in a form recorded on a computer readable recording medium such as a flexible disk, CD (CD-ROM, CD-R, CD-RW, etc.), DVD (DVD-ROM, DVD-RAM, DVD-R, DVD+R, DVD-RW, DVD+RW, HD DVD, etc.), blue-ray disk, magnetic disk, optical disk, opto-magnetic disk, etc. In this case, a computer reads the program from the recording medium, transfers it to an internal storage device or an external storage device, and stores it for use. Further, the program may be recorded on a storage device (a recording medium) such as a magnetic disk, an optical disk, an opto-magnetic disk or the like and provided to a computer from the storage device via a communication line.

When the functions as the exclusion manager 31, the processing order manager 32, the transfer controller 33, the assigner 34, the individual tread manager 35, the re-entry processor 36, the processor information controller 37, the suppression setting information controller 38, the lock controller 39, the exclusion controller 40, the suppression controller 41, and the thread set generator 42 are realized, the program stored on an internal storage (memory 11 or the like in these embodiments) is executed by a microprocessor of the computer. On this occasion, the program recorded on the recording medium may be read out and executed by the computer.

In this embodiment, a computer is a concept including hardware and an operating system, and signifies hardware that operates under the control of the operating system. Further, when hardware is operated with an application program alone without an operating system, the hardware itself corresponds to a computer. Hardware is provided with at least a microprocessor such as a CPU or the like, and a means to read a program recorded on a recording medium. In these embodiments, the information processing apparatus 1 has a function as the computer.

The thread scheduler 30 has one MutexQ (second managing queue) and one MSGQ (first managing queue), as illustrated in FIG. 3. Each of the MutexQ and the MSGQ is provided to not each task but to one information processing apparatus 1.

The MSGQ is a queue which manages command blocks CB in a lock acquired state under the exclusive control, in which a command block in a lock-acquired, processible state (lock acquired state) is registered. Hereinafter, “registering” a command block in a queue is occasionally expressed as “concatenating” or “connecting” the command block.

The command block CB is a functional unit that is to be executed (processed) in threads. For example, the command block CB is a read command or a write command transmitted and accepted from the host 2 which is an upper apparatus.

Command blocks CB registered in the MSGQ are successively read out by the assigner 34 to be described later in FIFO (First in, First out) fashion. The read command block CB is handed to a thread of a corresponding task, and executed in the thread.

In these embodiments, when a new command block CB is processed, the process should transit in a predetermined thread execution order. Namely, the new command block CB is first processed in a thread A, thereafter, always handed to a thread B, and handed to a thread C in that order.

In the information processing apparatus 1 in which the command block CB is processed in thread A, thread B and thread C in that order after the command is accepted, a combination of the plural threads A, B and C whose processing order is predetermined is called a thread set. Namely, in a thread set, plural kinds of threads having respective specific functions are arranged in a predetermined processing order.

To the command block CB, a CPU-in-charge number (processor identification information) and thread exclusion information are attached, as illustrated in FIG. 4.

The CPU-in-charge number is information specifying the next CPU core 20 that is to process the command block CB, and the afore-mentioned CPU identification number is used for the CPU-in-charge number, for example. The CPU-in-charge number is set by the processor information controller 37 to be described later.

The thread exclusion information is information relating to exclusion setting about the command block between threads. The thread exclusion information has a thread exclusion ID and an exclusion state flag.

The thread exclusion ID is information indicating a thread to be excluded. The exclusion state flag is information representing whether the command block CB is in a state in which the command block has acquired an exclusion lock (exclusion lock acquired state) or not.

The command block CB includes a CPU-in-charge number, a thread exclusion ID, an exclusion state flag, a data address indicating a data storage area in which data such as functions and the like are stored, a CPU affinity flag, etc., which are associated with one another.

The CPU affinity flag (suppression setting information) is a flag which is set when a strong CPU affinity function is made valid. The strong CPU affinity is to realize an exclusive control on the hardware resource by fixing a CPU core 20 to each command block accessing to a specific hardware resource, without occurrence of contention in accessing to the hardware resource and without the use of a manner such as SpinLock or the like. The strong CPU affinity function will be described later, in detail.

The MutexQ is a queue which manages command blocks CB in the lock acquisition waiting state under the exclusive control. To the MutexQ, registered is a command block CB in a state in which this command block is inexecutable because another command block CB has already acquired the lock, thus this command block waits to acquire the lock.

The command block CB registered in the MutexQ is read out by the processing order manager 32 to be described later, handed to a thread of a corresponding task, and executed (processed) in the thread.

According to this embodiment, when a command block CB connected to the MutexQ gets into the lock acquired state, the command block CB is released from the MutexQ by the transfer controller 33, and registered in the MSGQ.

The MutexQ connects storage addresses of data of a plurality of command blocks CB in the memory 11 one after another in a row to manage the command blocks, as illustrated in FIG. 5. For example, the MutexQ holds the leading address in an area in which a command block CB that is the forefront in the MutexQ is stored, and holds the leading address of an area in which the leading address of the following command block is stored as NEXT, in each command block registered in the MutexQ.

Like the MutexQ, the MSGQ connects storage addresses of data of plural command blocks in the memory 11 one after another in a row, thereby to manage them. Namely, the MSGQ holds the leading address of an area in which the forefront command block in the MSGQ is stored, and holds the leading address of the following command block CB as NEXT, in each command block CB registered in the MSGQ.

In the example illustrated in FIG. 5, there is illustrated a data structure of one command block CB, for the sake of convenience.

By successively tracing the NEXTs, it is possible to obtain each command block registered in the MutexQ or MSGQ. By appropriately rewriting an address of the leading command block or a value of NEXT, it is possible to register an arbitrary command block CB in the MutexQ or MSGQ, or detach (release) a specific command block CB from the MutexQ or MSGQ.

The exclusion manager 31 manages a command block CB in the lock acquisition waiting state under the exclusive control with the use of the above-mentioned MutexQ.

The processing order manager 32 manages a command block CB in the lock acquired state under the exclusive control with the use of the above-mentioned MSGQ.

When a command block in the lock acquisition waiting state registered in the MutexQ gets into the lock acquired state, the transfer controller 33 performs a control to release the command block CB from the MutexQ and register the same in the MSGQ.

The thread set generator 42 duplicates the aforementioned thread set to make thread sets equal in number to the CPU cores 20. As this, the thread set generator 42 generates thread sets equal in number to the CPU cores 20 and assigns a thread set to each of the CPU cores 20, thereby operating the command process in each of the CPU cores 20, which leads to an increase of the degree of parallelism of the command processing.

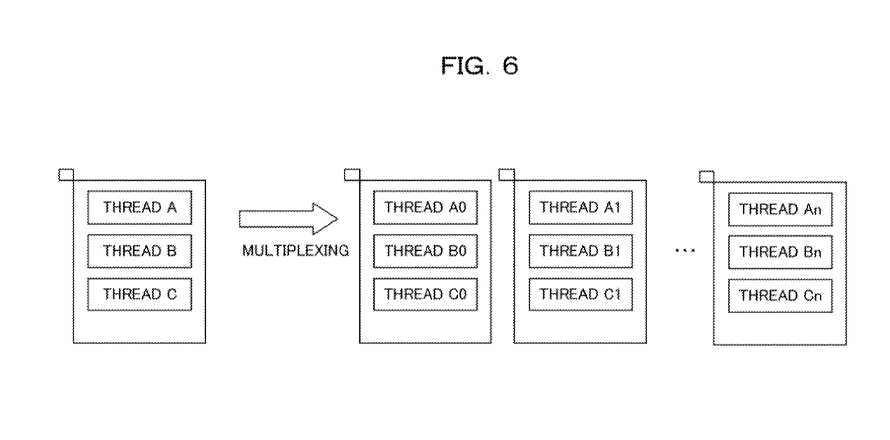

FIG. 6 is a diagram illustrating a state in which a thread set is duplicated and multiplexed in the information processing apparatus 1 as one example of the embodiments.

In the example illustrated in FIG. 6, there is illustrated a state in which thread A is multiplexed to yield threads A0, A1, . . . and An, thread B is multiplexed to yield threads B0, B1, . . . and Bn, and thread C is multiplexed to yield threads C0, C1, . . . and Cn.

The lock controller 39 performs the exclusive control to exclusively execute the same thread among a plurality of CPU cores 20. For example, while thread A is executed in any one (for example, CPU core #2) of the CPU cores 20, the thread A is not executed in the other CPU cores (for example, CPU core #1, and #3 to #n), at the same time.

Further, the same threads multiplexed and yielded by the thread set generator 42 are not simultaneously executed. In other words, threads A0, A1, . . . and An are not executed simultaneously. Similarly, threads B0, B1, . . . and Bn are not simultaneously executed, and thread C0, C1, . . . and Cn are not simultaneously executed, as well.

The lock controller 39 sets a thread exclusion ID to a command block CB, and gives an execution permission (gives a lock right) to only one command block CB in one period among command blocks CB having the same thread exclusion ID. Incidentally, a command block CB to which the lock right to a thread has been given is called a lock acquired sate, while any command block CB does not acquire the lock right to the thread is called a lock unacquired state.

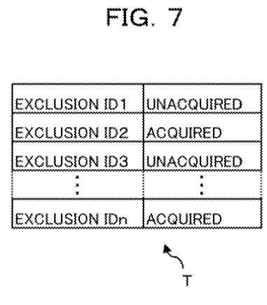

The lock controller 39 registers the lock acquired state in an exclusion ID management table T. FIG. 7 is a diagram illustrating an example of the exclusion ID management table T in the information processing apparatus 1 as one example of the embodiments.

In the exclusion ID management table T, information representing that the exclusion ID is in the lock acquired state (“acquired” in the example in FIG. 7) or information representing that the exclusion ID is in the lock unacquired state (“unacquired” in the example in FIG. 7) is registered in association with each exclusion ID, as illustrated in FIG. 7.

The processor information controller 37 sets the afore-mentioned CPU-in-charge number in a command block CB. The processor information controller 37 sets a CPU identification number as the CPU-in-charge number in a specific area in the command block CB, as illustrated in FIG. 5.

The exclusion controller 40 sets the above-mentioned thread exclusion information in a command block CB. The exclusion controller 40 sets a thread exclusion ID and an exclusion state flag in specific areas in a command block CB, as illustrated in FIG. 5.

The assigner 34 assigns a command block CB managed by the MSGQ to a CPU core 20. The assigner refers a CPU-in-charge number contained in a command block CB, for example, and assigns the command block CB to a CPU core 20 (task) corresponding to the CPU-in-charge number.

When the CPU-in-charge number is not registered in the command block, the command block CB may be processed in any CPU core 20. In such case, the assigner 34 assigns the command block CB to a CPU core 20 to which any process is not assigned (idle) at that time or a CPU core 20 that first gets into the idle state.

In the case where, when the assigner 34 tries to assigns a command block CB to a CPU core 20 but the CPU core 20 corresponding to the command block CB is unfortunately in execution of another process, the suppression controller 41 suppresses the process by the assigner 34 until the CPU core 20 finishes the process which is being executed. The function of the suppression controller 41 is made valid when a set value (for example, “1”) signifying that the strong CPU affinity function is valid is set at the CPU affinity flag in the command block CB. For example, when “1” is set to the CPU affinity flag in the command block CB, the strong CPU affinity function is made valid. On the other hand, when the CPU affinity flag in the command block CB is set to a setting that the strong CPU affinity is invalid (for example, “0”), the suppression controller 41 does not suppress the process by the assigner 34. The CPU affinity flag is set by the suppression setting information controller 38.

The suppression setting information controller 38 sets the CPU affinity flag representing whether to make valid the function of the suppression controller 41 or not. The suppression setting information controller 38 sets “1” to the CPU affinity flag of a command block CB when, for example, the operator performs an input operation to make the strong CPU affinity valid through an input device such as a keyboard, mouse or the like (not illustrated).

The individual thread exclusion manager 35 manages command blocks CB for each thread in the lock acquisition waiting state under the exclusive control, managing the command blocks CB in the lock acquisition waiting state in the order in which the commands have been accepted from the host 2. The individual thread exclusion manager 35 manages command blocks CB in the lock acquisition waiting state, thread by thread, with the use of a queue (exclusion ID queue) made for each exclusion ID, as will be described later.

The re-entry processor 36 again registers a command block CB processed in the thread into the forefront in the MutexQ.

Hereinafter, various functions of the scheduler 30 of the information processing apparatus 1 will be described.

### (1) Thread Multiplexing Function

In the information processing apparatus 1, a command is processed in thread A, thread B and thread C in that fixed order after accepted by the threads. For this reason, the degree of parallelism of the command processing and the processing performance is not be improved only by dynamically assigning threads to a plurality of CPU cores 20, simply. The thread set generator 42 duplicates a thread set composed of thread A, thread B and thread C to increase the degree of parallelism of the command processing. In these embodiments, the thread set generator 42 generates thread sets equal in number to the (n) CPU cores 20 provided in the processor unit 14.

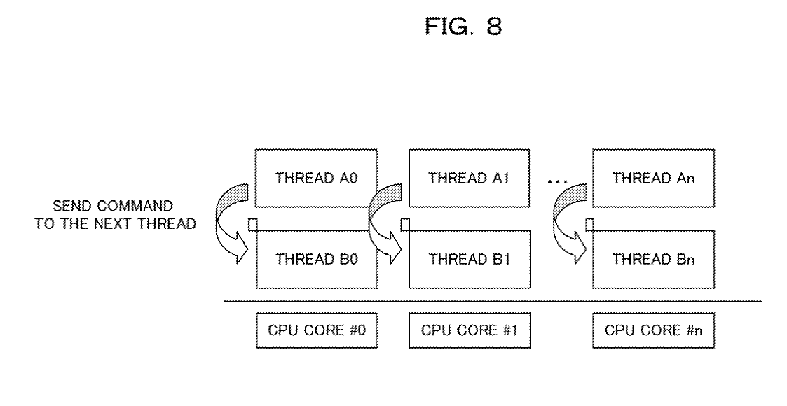

FIG. 8 is a diagram schematically illustrating sending of a command block CB in the information processing apparatus 1 as one example of the embodiments.

As illustrated in FIG. 8, generating a plurality of thread sets makes it possible to perform the command processing in parallel, with the use of a plurality of CPU cores 20, to efficiently process tasks, and to attain thread transition in each CPU core 20.

In the information processing apparatus 1 as one example of the embodiments, the command block CB can continuously process in a thread set on the same CPU core 20, which improves the hit rate of the CPU cache in each CPU core 20 and further improves the performance.

### (2) Exclusion Function Among Threads

The degree of parallelism can be increased by multiplying thread sets, as stated above. However, this may increase the overhead of the exclusion process among the threads with respect to the common resource. To avoid this risk, a function of limiting the parallel operation for each thread can minimize the overhead of the exclusion process.

In the information processing apparatus 1, any one of the threads A0, A1, A2, . . . and An, for example, can operate on only one CPU 20 at a time by means of the exclusion process among threads, as stated hereinbefore. Whereby, the exclusion process among threads with respect to the common resource that is to be used only by a thread Ax (x is an integer from 0≦x≦n) becomes unnecessary.

Here, exclusion of threads A0, A1, . . . and An generated by multiplying thread A is called a thread exclusion ID1 (expressed as ID1, occasionally).

Similarly, exclusion of threads B0, B1, . . . and Bn generated by multiplying thread B is called a thread exclusion ID2 (expressed as ID2, occasionally).

Further, exclusion of threads C0, C1, . . . and Cn (expressed as ID3, occasionally) generated by multiplying thread C is called thread exclusion ID3.

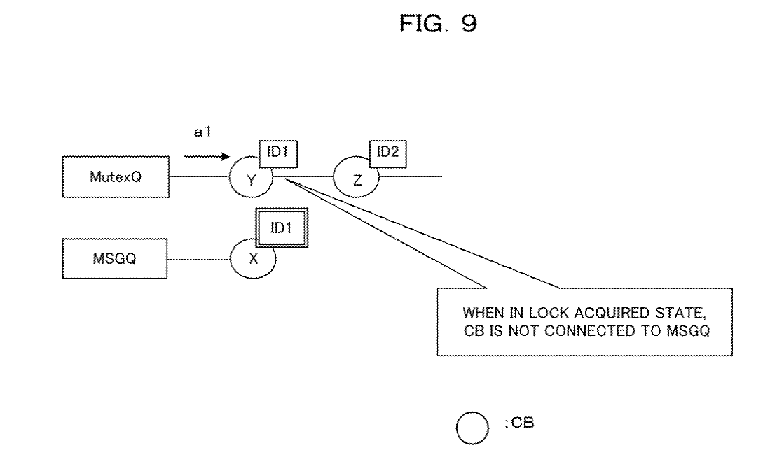

Next, a practical manner of thread exclusion in the scheduling by the scheduler 30 will be described with reference to FIGS. 9 to 11.

FIGS. 9 to 11 are diagrams illustrating the exclusion function among threads in the information processing apparatus as one example of the embodiments.

In the drawings, a thread exclusion ID in a double-line square represents the lock acquired state, while a thread exclusion ID in a single-line square represents the lock acquisition waiting state.

Namely, a state in which the exclusion state flag is “1” is represented by a thread exclusion ID in a double-line square, while a state in which the exclusion state flag is “0” is represented by a thread exclusion ID in a single-line square.

In a state illustrated in FIG. 9, command blocks CB [Y] and [Z] in the lock acquisition waiting state are concatenated in the MutexQ, while a command block CB [X] is concatenated in the MSGQ.

In the state illustrated in FIG. 9, since the thread exclusion ID1 is in the lock state, the command block CB [Y] is not concatenated in the MSGQ.

(a1) The scheduler 30 searches for a command block CB in the MutexQ, starting with the front command block CB (see a1 in FIG. 9), and evaluates the command block CB [Y] which is the forefront in the MutexQ.

A thread exclusion ID1 for this thread A is the lock acquired state, the scheduler 30 thus searches for the next command block CB.

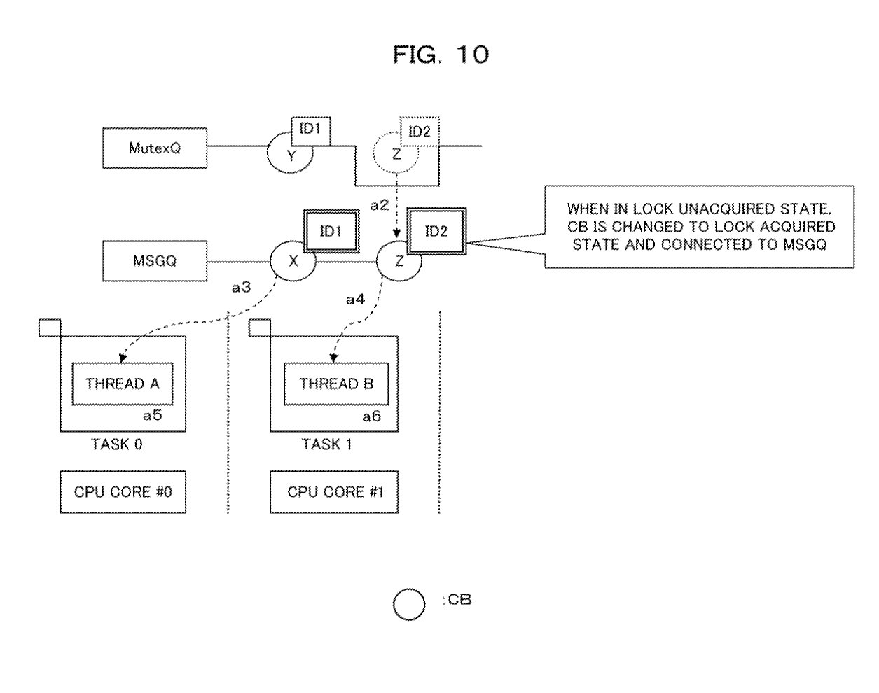

(a2) Next, the scheduler 30 evaluates a command block CB [Z] in the MutexQ. Since a thread exclusion ID2 for the thread B is the lock unacquired state, the transfer controller 33 changes the state of the command block CB [Z] to the lock acquired state, detaches the command block CB [Z] from the MutexQ, and connects the same to the MSGQ (see a2 in FIG. 10).

(a3) In the MSGQ, only connected is a command block CB whose thread exclusion ID is the lock acquired state. Thus, the assigner 34 assigns the front command block CB [X] to a task 0 operating on the CPU core #0. A thread scheduler in the task 0 operating on the CPU core #0 executes the command block CB [X] (see a3 in FIG. 10).

(a4) The assigner 34 next assigns the command block CB [Z] to a task 1 operating on the CPU core #1. A thread scheduler in the task 1 operating on the CPU core #1 executes the command block CB [Z] (see a4 in FIG. 10).

(a5) When the command block CB [X] is completed (see a5 in FIG. 10), the lock controller 39 changes the state of the thread exclusion ID1 of the thread A to the lock unacquired state.

(a6) When the command block CB [Z] is completed (see a6 in FIG. 10), the lock controller 39 changes the state of the thread exclusion ID2 of the thread B to the lock unacquired state. Whereby, another command block CB comes to be able to acquire the lock.

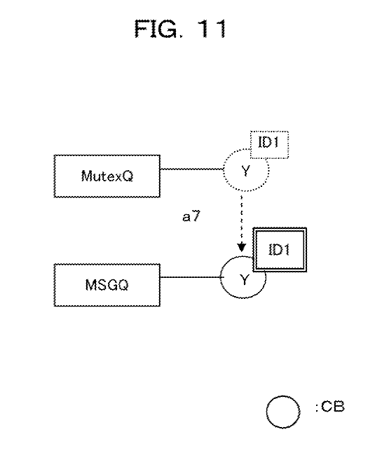

(a7) Since the thread exclusion ID1 of the thread A of the command block CB [Y] becomes the lock unacquired state at (a5), the transfer controller 33 changes the state of the command block CB [Y] to the lock acquired state in the similar manner to the above (a2), and connects the command block CB [Y] to the MSGQ (see a7 in FIG. 11)

Thereafter, the similar process at (a3) to (a6) is repeated.

Meanwhile, a task/thread not multiplexed can be directly connected to the MSGQ.

In the information processing apparatus 1 as one example of the embodiments, the exclusion process among threads can be accomplished in an SMP, with the use of MutexQ. For example, a common resource used only by a specific thread becomes available without exclusion process among the threads.

### (3) Command Execution Order Assurance Function

The information processing apparatus 1 has a function of processing commands in the order in which the commands have been accepted from the host 2 even when the command parallel processing is realized in the SMP environments. Namely, use of MutexQ can realize the command execution order assurance in the order in which commands have been accepted from the host 2 in the SMP environments.

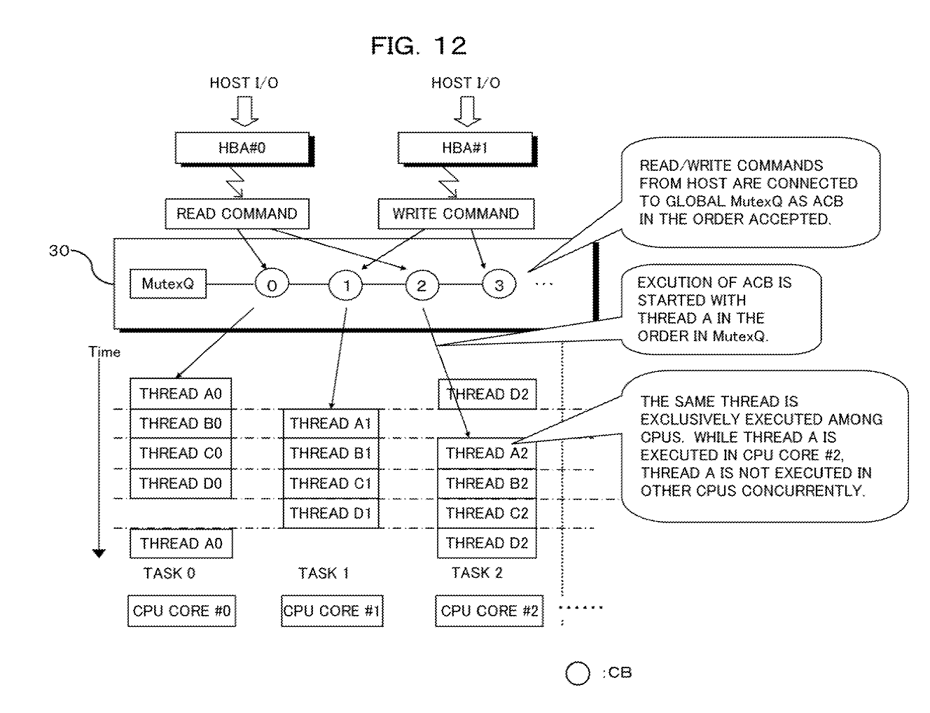

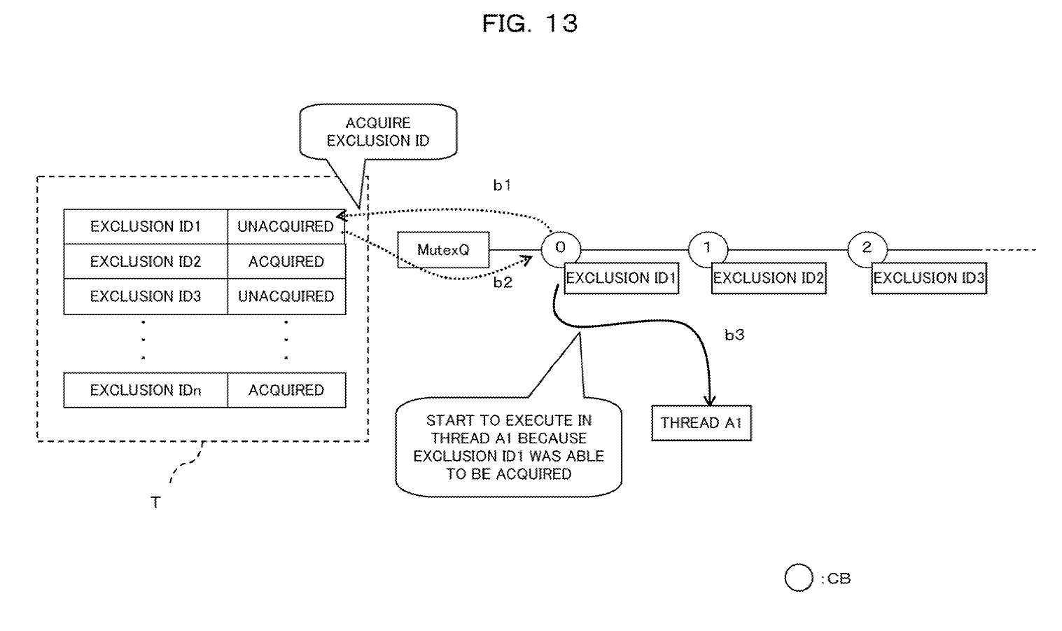

FIG. 12 is a diagram illustrating the command execution order assurance function in the information processing apparatus 1 as one example of the embodiments. FIG. 13 is a diagram illustrating a manner of referring an exclusion ID management table.

As illustrated in FIG. 12, read commands or write commands accepted from the host 2 are connected as command blocks CB to the MutexQ in the order in which the commands have been accepted. In the scheduler 30, the transfer controller 33 evaluates acquisition of thread exclusion of a command block, starting with the front command block CB in the MutexQ, and connects one that have been able to first acquire the thread exclusion to the MSGQ.

In other words, execution of the command blocks CB is done in the order in which the command blocks CB have been connected to the MutexQ, starting with the thread A. Since the MutexQ is global and shared among the tasks, the execution order of command blocks CB connected in the MutexQ is assured. As illustrated in FIG. 12, the same thread is exclusively executed among the CPU cores 20.

In the example illustrated in FIG. 13, the lock controller 39 refers the exclusion ID management table T with respect to the front command block CB [0] in the MutexQ, and confirms the exclusion state of the exclusion ID1 of the command block CB [0] (see b1 in FIG. 13). In the example illustrated in FIG. 13, the exclusion ID1 is the lock unacquired state (unacquired), the command block CB [0] thus acquires exclusion ID1 (see b2 in FIG. 13).

The command block CB [0] that have been able to acquire the exclusion ID1 is executed in the thread A1, for example (see b3 in FIG. 13).

As this, the information processing apparatus 1 as one example of the embodiments registers command blocks CB in the MutexQ in the order in which the commands have been accepted from the host 2. Whereby, the command execution order is assured in the SMP environments, and the commands are executed in the order in which the commands have been accepted from the host 2.

### (4) Modification of Command Execution Order Assurance Function

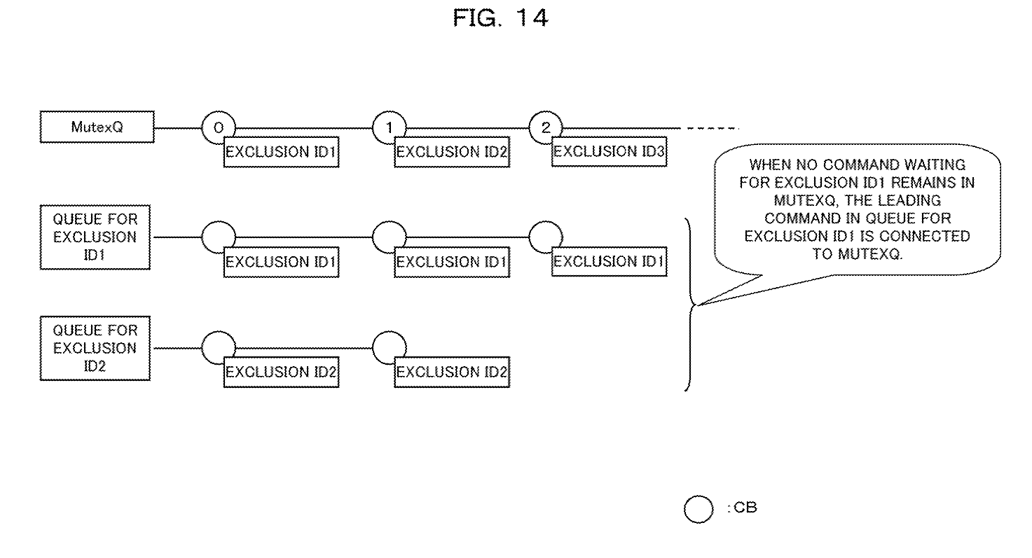

FIG. 14 is a diagram illustrating a modification of the command execution order assurance function in the information processing apparatus 1 as one example of the embodiments.

In this modification, the individual thread exclusion manager 35 manages command blocks for each thread in the lock acquisition waiting state, with the use of exclusion ID queue made for respective exclusion IDs.

In the example illustrated in FIG. 14, the scheduler 30 has exclusion ID queues made for respective IDs such as a queue for exclusion ID1, a queue for exclusion ID2, . . . and so on, in addition to MutexQ.

In each of the queues for exclusion IDs, command blocks CB with respect to the same exclusion ID are registered in the order in which the commands have been accepted from the host 2.

Only the front command block CB in each queue of the corresponding exclusion ID is connected to the MutexQ. As this, only one of command blocks having the same exclusion ID is registered in the MutexQ.

For example, when a command block CB having exclusion ID1 is processed and disappears from the MutexQ, the individual thread exclusion manager 35 detaches the next (front) command block CB from the queue for exclusion ID1, and connects the same to the MutexQ. In the similar manner, when the command block CB of exclusion IDn disappears from the MutexQ, the individual thread exclusion manager 35 detaches the front command block CB from the queue for exclusion IDn, and connects the command block CB to the MutexQ.

As this, command blocks CB equal in number to the exclusion IDs are connected in the MutexQ. According to the information processing apparatus 1 as one example of the embodiments, checking in only MutexQ, starting with the front command block, is necessary when a command block CB is executed, which improves the searching speed for an executable command.

### (5) Weak CPU Affinity Function

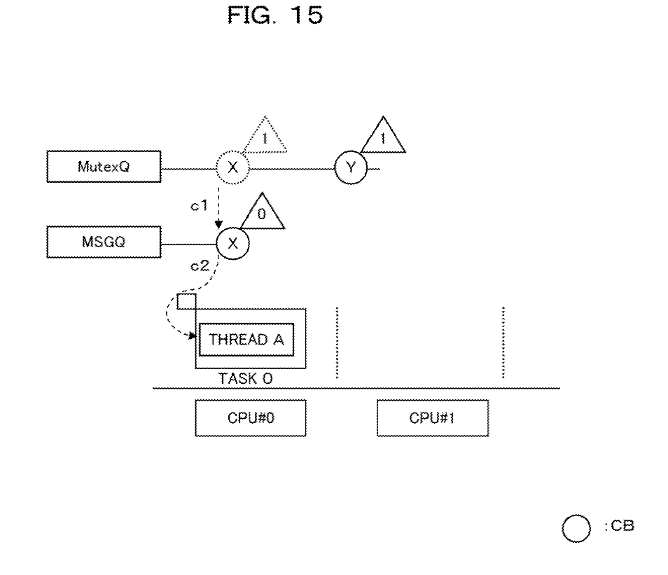

FIGS. 15 to 18 are diagrams illustrating a weak CPU affinity function in the information processing apparatus 1 as one example of the embodiments.

The weak CPU affinity function is a function that, when the thread transits, for example, from thread A to thread B, or from thread B to thread C, the process of a command block is continued on the same CPU core 20. Namely, transition among threads of the command block CB is accomplished on the same CPU core 20, thereby to improve the hit rate of the CPU cache and realize high-speed processing.

In concrete, the re-entry processor 36 sets a CPU number of a CPU core 20 that has processed a command block in prior to a CPU-in-charge number of a command block CB to be processed in a thread, and again registers the command block into the forefront in the MutexQ. Whereby, the command block CB is preferentially processed on the same CPU 20 as the CPU core 20 that has processed the command block CB in prior. This improves the hit rate of the CPU cache in the CPU core 20.

Next, a concrete manner of the weak CPU affinity function in the information processing apparatus 1 as one example of the embodiments will be described with reference to FIGS. 15 to 18. (c1) A thread scheduler in task 0 operating on the CPU core #0 searches for a command block CB in the MutexQ, starting with the front command block CB. When it is found as a result of the search that a command block CB [X] is executable, the transfer controller 33 connects the command block CB [X] in the MSGQ (see c1 in FIG. 15).

(c2) Only executable command blocks CB are connected in the MSGQ, the thread scheduler in the task 0 operating on the CPU core #0 thus executes the command blocks CB, starting with the front command block CB in the MSGQ. Namely, the command block CB [X] is executed in thread A (see c2 in FIG. 15).

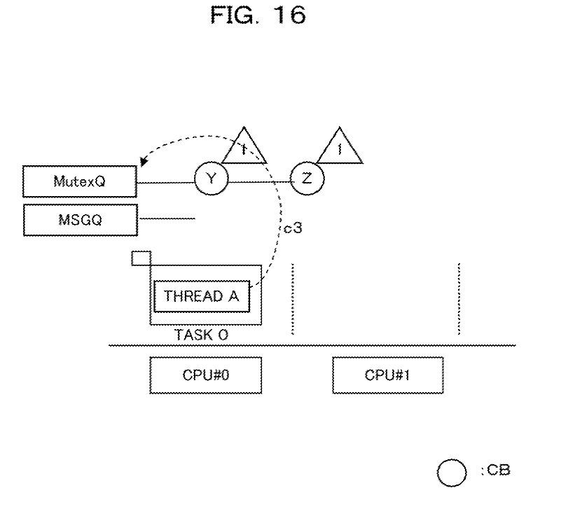

(c3) The thread A calls the next thread B via the thread scheduler, immediately before the process of the command block CB [X] is completed (see c3 in FIG. 16).

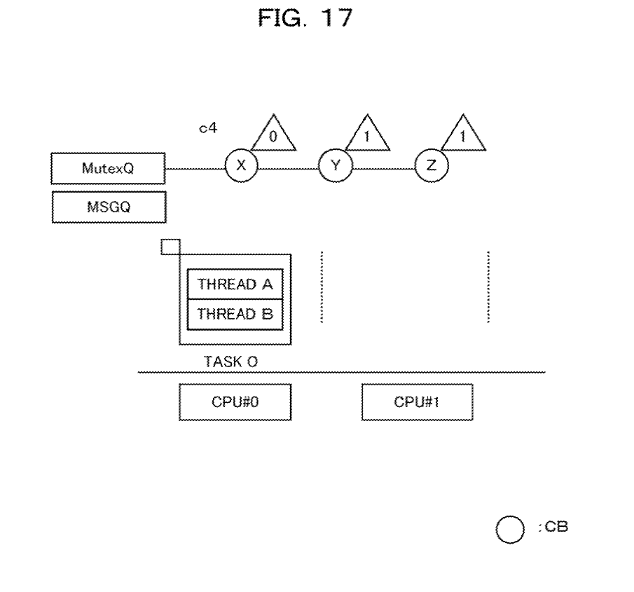

(c4) The re-entry processor 36 sets “0” which is a CPU number of the CPU core that has been working till now in a CPU-in-charge number area in the command block CB [X], and again connects the command block CB [X] as the forefront in the MutexQ (see c4 in FIG. 17).

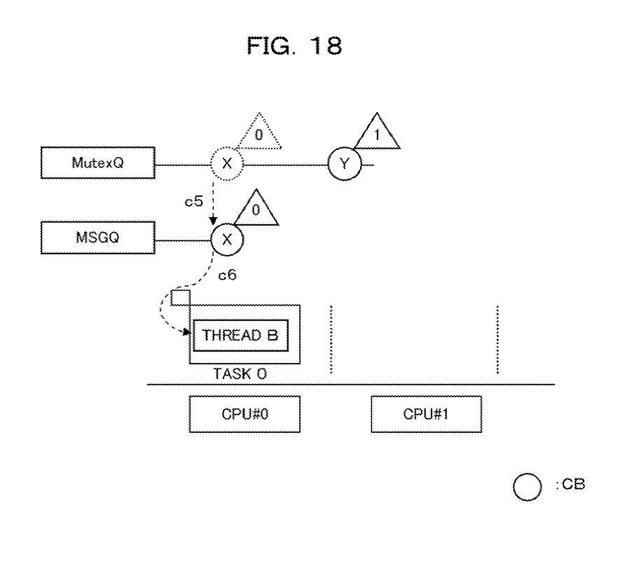

(c5) When the command block CB [X] becomes executable, the transfer controller 33 connects the command block CB [X] in the MSGQ (see c5 in FIG. 18).

(c6) The thread scheduler in task 0 operating on the CPU core #0 checks in the MSGQ, starting with the forefront, and executes the command block CB having the CPU-in-charge number=0, that is, the command block CB [X] (see c6 in FIG. 18).

As this, the command block CB [X] can be processed on the same CPU core as the CPU core that have processed the command block CB [X] immediately before, whereby the CPU cache hit rate is improved. Such effective use of the CPU cache facilitates speed-up of the process.

In the example illustrated in FIGS. 15 to 18, the weak CPU affinity is assured. However, the weak CPU affinity is not assured under certain conditions.

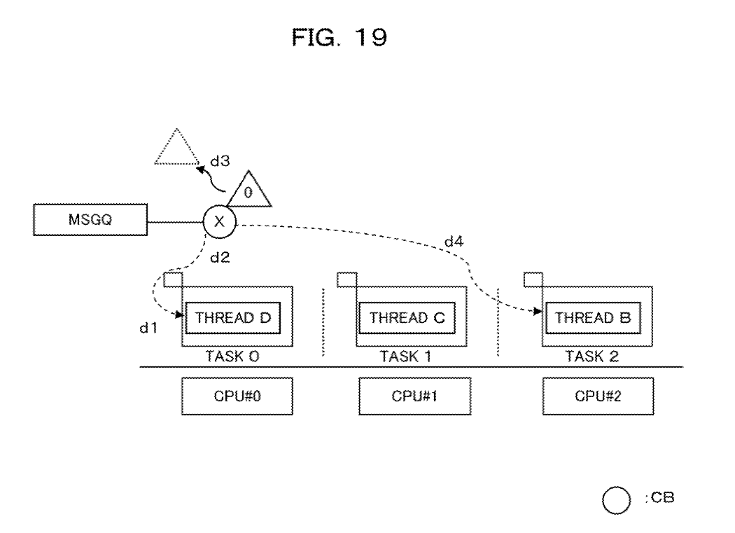

FIG. 19 is a diagram illustrating a case where the weak CPU affinity is not assured in the information processing apparatus as one example of the embodiments. A process to be performed when the weak CPU affinity is not assured in the information processing apparatus will be next described with reference to FIG. 19.

(d1) Assuming that a command block CB [X] having a CPU-in-charge number=0 and directed to thread B is connected in the MSGQ, but thread D is now operating owing to the interrupt processing or the like on the CPU #0 (see d1 in FIG. 19).

(d2) A thread scheduler for task 1 operating on the CPU core #1 tries to execute the next command block CB (see d2 in FIG. 19).

(d3) The thread scheduler for task 1 tries to execute the command block CB [X], but the CPU-in-charge number is “0”.

Since the thread D is now operating on the CPU core #0, the command block CB [X] is not executed. For this, the processor information controller 37 clears the CPU-in-charge number of the command block CB [X] connected in the MSGQ (see d3 in FIG. 19).

The reason of this is that even if the command block CB [X] is operated after some time has been elapsed, the probability of not hitting the CPU cache of the CPU core #0 is assumed to be high because the thread D is in operation on the CPU core #0.

Meanwhile, a command block CB [X] whose CPU-in-charge number is not registered can be processed on a CPU corer 20 that is idle at the time of a search for the next command block CB.

(d4) The thread scheduler for task 2 searches in the MSGQ, and executes the command block CB [X] on an idle CPU core 20 (see d4 in FIG. 19).

### (6) Strong CPU Affinity Function

SpinLock is known as a manner of acquiring exclusive use of the command resource such as hardware or the like in SMP environments. SpinLock is made for each common resource, and an access made to the common resource from one CPU core 20 under a state of securing SpinLock suppresses an access to the common resource from another CPU core 20.

As a demerit of SpinLock, wait for SpinLock acquisition occurs because the number of the competitors increases, it is thus important to decrease the frequency of use of SpinLock for the purpose of improvement of the performance.

In these embodiments, a strong CPU affinity function is provided for a driver accessing to the hardware resource. The strong CPU affinity function completely fixes a CPU core (access processor core) 20 to each block accessing to the hardware resource, thereby preventing occurrence of compete for the resource and enabling the process without SpinLock.

In concrete, a CPU core (access processor core) 20 is limited when an access to the hardware resource is made from the normal thread running level (for example, CPU core #1).

For example, only the CPU core #1 can have an access to a hardware resource A, whereby the exclusive control becomes unnecessary at the occasion of an access to the hardware resource A.

Response from the hardware resource to the CPU core 20 is made with an interrupt signal via a specific port of the driver, for example.

A CPU core 20 in which the interrupt processing from the hardware resource is running is the same as the CPU core 20 (for example, CPU core #1) which is allowed to have an access to the hardware resource. For example, a specific CPU core (active processor core) 20 is assigned to a specific port of the driver chip, and a command block CB transmitted from the thread is sent via this port. Whereby, responses from the hardware resource can be concentrated on the specific CPU core 20.

In order to allow coexistence of the strong CPU affinity function and the afore-mentioned weak CPU affinity function, a CPU-in-charge number in the command block CB is used. Namely, when a process including an access to the hardware resource occurs in each thread, the processor information controller 37 sets a CPU identification number of the access processor core to the CPU-in-charge number of a command block CB to perform this process.

Further, a CPU affinity flag (CPU affinity type area) is provided in the command block CB, and the suppression setting information controller 38 selectively sets information (flag) representing whether the strong CPU affinity function is valid or invalid to the CPU affinity flag.

When it is directed to make the strong CPU affinity function valid, the suppression controller 40 performs a control to wait the execution until the designated CPU 20 becomes available. In other words, the CPU-in-charge number is not cleared while the strong affinity function is executed.

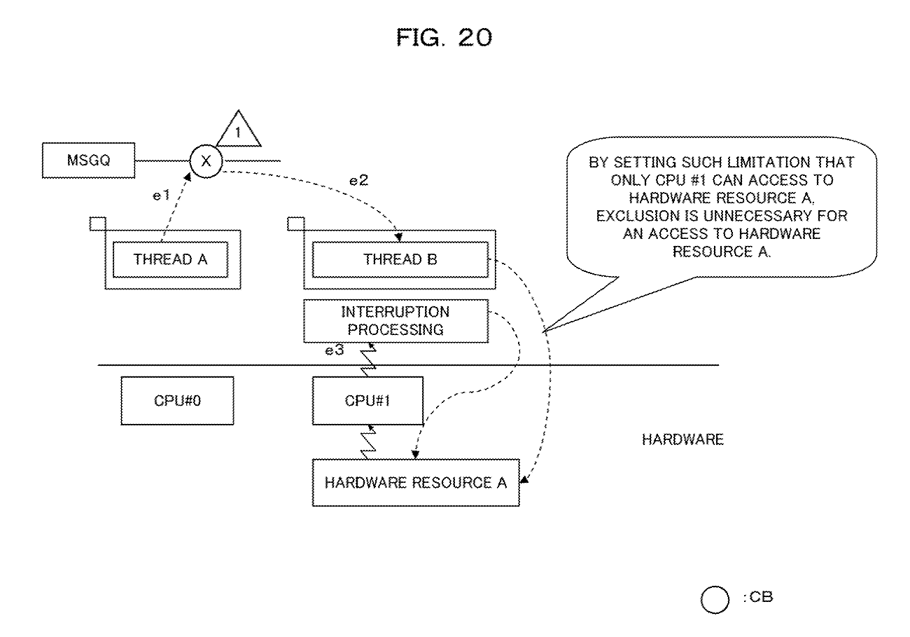

FIG. 20 is a diagram illustrating the strong CPU affinity function in the information processing apparatus 1 as one example of the embodiments. In the example illustrated in FIG. 20, the hardware resource A can be accessed from only the CPU core #1.

Hereinafter, the strong CPU affinity function will be described with reference to FIG. 20.

(e1) When the hardware resource A is accessed from the thread A via the thread B, the thread A first designates the CPU core #1 via the thread scheduler and calls the thread B (see e1 in FIG. 20).

(e2) Thereafter, the thread scheduler of the task 1 operating on the CPU core #1 checks the CPU-in-charge number of the command block CB [X], executes the command block CB [X], and accesses to the hardware resource A (see e2 in FIG. 20).

(e3) An interruption from the hardware resource A is sent to the CPU core #1, and the interrupt process is operated on the CPU #1 (see e3 in FIG. 20).

As above, in the information processing apparatus 1 as one example of the embodiments, a CPU core can be specified for a driver accessing to the hardware resource by the strong CPU affinity function. A CPU core 20 is fixed for each access block accessing to the hardware resource to suppress occurrence of compete for the resource without using SpinLock.

The information processing apparatus 1 as one example of the embodiments can process command blocks CB in parallel by a plurality of CPU cores 20, can improve the parallelism of the command processing and can increase the speed of the processing.

A thread set on the same CPU core 20 can continuously process a command block, which improves the hit rate of the CPU cache on each CPU core and improves and processing performance.

The exclusive processing among threads prevents concurrent execution of the same thread or the multiplexed same thread. Accordingly, the exclusive control among these threads is unnecessary with respect to the common resource used only by these threads, which increases the speed of the processing and decreases the management load.

By providing MutexQ, it becomes possible to process a plurality of command blocks CB in the order in which the commands have been accepted from the host 2, which assures the order.

The CPU affinity function is accomplished by giving a CPU-in-charge number as attribute information to a command block CB. Namely, continuously performed threads can be processed easily on the same CPU core 20, the hit ratio of the CPU cache can be improved and the processing can be sped up. With respect to a common resource such as the hardware resource or the like, an access to a specific common resource can be easily made from the same CPU core 20, which prevents occurrence of compete for the resource and enables the processing without SpinLock.

By giving thread exclusion information as attribute information to a command block CB, it becomes possible to readily accomplish thread exclusion in a multi-corer processor system.

An exclusion ID queue made for each exclusion ID is provided and only the forefront in the waiting queue for each exclusive ID is registered, whereby the search speed for a executable command can be increased.

Note that the disclosed techniques are not limited to the above-described embodiments, but can be modified in various ways without departing from the spirit and scope of the embodiments.

Further, disclosure of the embodiments enable persons skilled in the art to implement and manufacture the invention.

According to an aspect of the embodiment(s), the multi-core processor system and a computer readable recording medium recorded thereon a schedule management program can provide at least one of the following effects or advantages:

(1) task can be effectively processed;

(2) plural processor cores can process command blocks in parallel, which improves the parallelism of the command processing, and speeds up the processing;

(3) a plurality of command blocks can be processed in the order in which the commands have been accepted, which assures the order; and

(4) exclusive control among threads can be readily accomplished.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment(s) of the present invention has been described in detail, it should be understood that the various changes, substitutions, and alterations could be made hereto without departing from the spirit and scope of the invention.

What is claimed is:

1. A multi-core processor system having a plurality of processor cores and executing a task having a plurality of threads to be implemented in a specific execution order in each of the processor cores, the multi-core processor system comprising:
a processing order manager that manages a command block in a lock acquired state under exclusive control;
an assigner that assigns the command block managed by the processing order manager to one of the processor cores;
an exclusion manager that manages a command block in a lock acquisition waiting state under the exclusive control; and
a transfer controller that, when the command block in the lock acquisition waiting state managed by the exclusion manager gets into the lock acquired state, releases the command block from the exclusion manager, and registers the command block in the processing order manager.

2. The multi-core processor system according to claim 1, wherein the exclusion manager registers each of command blocks in the exclusion manager in order of acceptance of commands from a host;
the transfer controller registers each of the command blocks having been registered in the exclusion manager in the processing order manager in order of entry in the exclusion manager; and
the assigner assigns each of the command blocks to a corresponding processor core in order of entry of the command blocks in the processing order manager.

3. The multi-core processor system according to claim 1, wherein the exclusion manager manages the command blocks corresponding to respective threads, separately.

4. The multi-core processor system according to claim 3 further comprising:
an individual thread exclusion manager that manages command blocks in the lock acquisition waiting state under the exclusive control for each of threads, in order of acceptance of commands from the host;
when the exclusion manager releases a command block, the individual thread exclusion manager registers a command block, which is at a leading position in a queue of command blocks arranged in order of acceptance of commands for a thread corresponding to the released command block, in the exclusion manager.

5. The multi-core processor system according to claim 2 further comprising:
a re-entry processor that re-registers a command block processed in the thread at a leading position in a queue of command blocks in the lock acquisition waiting state in the exclusion manager.

6. The multi-core processor system according to claim 5 further comprising:
a processor information controller that sets processor identification information indicating a processor core to process a command block in the command block; and
the processor information controller sets the processor identification information specifying the processor core having processed the command block in the command block.

7. The multi-core processor system according to claim 6, wherein, when a processor core in a processible state differs from a processor core corresponding to the processor identification information set in the command block, the processor information controller clears the processor identification information set in the command block.

8. The multi-core processor system according to claim 6, wherein a processor core to access to a hardware resource is beforehand specified as an access processor core; and
the processor information controller sets the processor identification information corresponding to the access processor core to a command block relating to a process in which an access to the hardware resource occurs.

9. The multi-core processor system according to claim 8 further comprising:
a suppression controller that, when the assigner tries to assign a command block to the access processor core but the access processor core corresponding to the command block is in course of execution of another process, suppresses the process by the assigner until the access processor core completes the relevant process.

10. The multi-core processor system according to claim 9 further comprising:
a suppression setting information controller that sets suppression setting information representing whether to make a function by the suppression controller valid or not in the command block.

11. The multi-core processor system according to claim 1 further comprising:
an exclusion controller that sets thread exclusion information representing exclusion setting among threads for the command block in the command block; and
reading of a thread is done based on the thread exclusion information set by the exclusion controller.

12. A computer readable recording medium recorded thereon a schedule management program instructing a computer to execute a scheduling function in a multi-core processor system having a plurality of processor cores and executing a task having a plurality of threads to be implemented in a specific execution order in each of the processor cores;
the schedule management program instructing the computer to function as:
a processing order manager that manages a command block in a lock acquired state under exclusive control;
an assigner that assigns the command block managed by the processing order manager to one of the processor cores;
an exclusion manager that manages a command block in a lock acquisition waiting state under the exclusive control; and
a transfer controller that, when the command block in the lock acquisition waiting state managed by the exclusion manager gets into the lock acquired state, releases the command block from the exclusion manager, and registers the command block in the processing order manager.

13. The computer readable recording medium recorded thereon a schedule management program according to claim 12, wherein the schedule management program registers each of the command blocks in the exclusion manager in order of acceptance of commands from a host when instructing the computer to function as the exclusion manager;
registers each of the command blocks having been registered in the exclusion manager in the processing order manager in order of entry in the exclusion manager when instructing the computer to function as the transfer controller; and
assigns each of the command blocks in the processing order manager to a corresponding processor core in order of entry of the command blocks in the processing order manager when instructing the computer to function as the assigner.

14. The computer readable recording medium recorded thereon a schedule management program according to claim 12, wherein the schedule management program manages command blocks corresponding to respective threads, separately, when instructing the computer to function as the exclusion manager.

15. The computer readable recording medium recorded thereon a schedule management program according to claim 14, wherein the schedule management program instructs the computer to function as an individual thread exclusion manager that manages command blocks in the lock acquisition waiting state under the exclusive control, for each of threads, in order of acceptance of commands from the host; and
when the exclusion manager releases a command block, the individual thread exclusion manager registers a command block, which is at a leading position in a queue of command blocks arranged in order of acceptance of commands for a thread corresponding to the released command block, in the exclusion manger when instructing the computer to function as the exclusion manager.

16. The computer readable recording medium recorded thereon a schedule management program according to claim 13, wherein the schedule management program instructs the computer to function as:
a re-entry processor that re-registers a command block having been processed in the thread at a leading position in a queue of command blocks in the lock acquisition waiting state in the exclusion manager.

17. The computer readable recording medium recorded thereon a schedule management program according to claim 16, wherein the schedule management program instructs the computer to function as:
a processor information controller that sets processor identification information indicating a processor core to process a command block in the command block; and
the schedule management program sets the processor identification information specifying the processor core having processed the command block in the command block when instructing the computer to function as the processor information controller.

18. The computer readable recording medium recorded thereon a schedule management program according to claim 17, wherein the schedule management program beforehand specifies a processor core to access to a hardware resource as an access processor core; and
sets the processor identification information corresponding to the access processor core in a command block relating to a process in which an access to the hardware resource occurs when instructing the computer to function as the processor information controller.

19. The computer readable recording medium recorded thereon a schedule management program according to claim 12, wherein the schedule management program instructs the computer to function as an exclusion controller that sets thread exclusion information representing exclusion setting among threads for the command block in the command block; and
does reading of a thread based on the thread exclusion information set by the exclusion controller.

20. A method for processing a task having a plurality of threads to be implemented in a specific execution order, in processor cores included in a multi-core processor system, comprising:
managing a command block in a lock acquired state under exclusive control using a first managing queue;
assigning the command block managed in the first managing queue to one of the processor cores;
managing a command block in a lock acquisition waiting state under the exclusive control using a second managing queue; and
when the command block in the lock acquisition waiting state managed in the second managing queue gets into the lock acquired state, releasing the command block from the second managing queue, and registering the command block in the first managing queue.
